(19) United States
(12) Patent Application Publication
(10) Pub. No.: US 2016/0170955 A1
(43) Pub. Date: Jun. 16, 2016

(54) METHOD, DEVICE AND RECORDING MEDIUM FOR PROCESSING WEB APPLICATIONS

(71) Applicant: Samsung Electronics Co., Ltd., Gyeonggi-do (KR)

(72) Inventors: Yoon-Chan CHOI, Gyeonggi-do (KR); Joo-Hyun KIM, Gyeonggi-do (KR)

(73) Assignee: Samsung Electronics Co., Ltd.

(21) Appl. No.: 14/962,826

(22) Filed: Dec. 8, 2015

(30) Foreign Application Priority Data
Dec. 12, 2014 (KR) 10-2014-0179165

(51) Int. Cl. G06F 17/24

(52) U.S. Cl. CPC G06F 17/248

(57) ABSTRACT

A method, a device and a non-transitory computer-readable recording medium for processing a web application in an electronic device is provided. The method includes loading a template of the web application, receiving an input of content corresponding to the loaded template, and combining the input of content with the loaded template to create the web application. The device includes a memory configured to store a template of a web application, and a processor configured to load the template of the web application, receive an input of content corresponding to the template, and combine the input content with the loaded template to create the web application.

### PRIORITY

This application claims priority under 35 U.S.C. §119(a) to a Korean Patent Application filed on Dec. 12, 2014 in the Korean Intellectual Property Office and assigned Serial No. 10-2014-0179165, the entire contents of which are incorporated herein by reference.

### BACKGROUND

1. Field of Invention

The present invention relates generally to a method and a device for processing web applications in an electronic device, and more particularly, to a method and a device for processing a web application by which a user can edit a web application written in a form of a template by a developer by adding content thereto, to thereby easily create a web application.

2. Description of the Related Art

Web applications may be executed on web browsers. The web applications may perform various functions such as web mail, web pages, games, or the like. Web applications may be created using technology such as HyperText Mark-up Language (HTML), Java Script (JS), a Cascading Style Sheet (CSS), or the like.

Since the creation of web applications requires technology related thereto, it is almost impossible for ordinary users to create web applications.

In order to edit a web application created by a developer, code of the application must be analyzed and modified, which is a difficult and tedious job for most people. Thus, it is almost impossible for ordinary users other than the developer to edit web applications. Therefore, it is not easy to add content to a web application created by a developer and share the same with a plurality of users. In addition, an entire web application must be downloaded in order to use the web application, and thus it may take a long time to download a web application.

### SUMMARY

The present invention has been made to address the above-mentioned problems and disadvantages, and to provide at least the advantages described below. Accordingly, an aspect of the present invention provides a method, a device and a recording medium for processing web applications by which ordinary users can edit a web application written in a form of a template by a developer by adding content thereto, to thereby easily create a web application.

Another aspect of the present invention provides a method, a device and a recording medium for processing web applications by which ordinary users can edit a web application created in a form of a template by a developer to thereby create a web application, and store the created web application in a shared storage space so that a plurality of users can access the shared storage space to share the web application.

Another aspect of the present invention provides a method, a device and a recording medium for processing web applications by which templates of the web applications, which are created based on templates to be shared, are cached in an electronic device, and the shared web applications may be executed by using the cached templates so that a loading time for executing the web applications can be reduced.

In accordance with an aspect of the present invention, a method of processing a web application in an electronic device is provided. The method includes loading a template of the web application, receiving an input of content corresponding to the loaded template, and combining the input of content with the loaded template to create the web application.

In accordance with another aspect of the present invention, a method of processing a web application in an electronic device is provided. The method includes receiving a selection of at least one web application created on a basis of a template, loading a template of the selected web application, downloading content of the selected web application from a shared storage space that stores the web application, and combining the downloaded content with the loaded template to complete the selected web application.

In accordance with another aspect of the present invention, a method of processing a web application in a server is provided. The method includes receiving the web application created on a basis of a template, storing the received web application in a shared storage space, receiving a request for content of the web application from an electronic device, and transmitting the content of the web application requested by the electronic device from the shared storage space to the electronic device that requested the content.

In accordance with another aspect of the present invention, an electronic device is provided. The electronic device includes a memory configured to store a template of a web application, and a processor configured to load the template of the web application, receive an input of content corresponding to the template, and combine the input content with the loaded template to create the web application.

In accordance with another aspect of the present invention, an electronic device is provided. The electronic device includes a memory configured to store a template of a web application, and a processor configured to receive a selection of at least one web application created on a basis of a template, load a template of the selected web application, download content of the selected web application from a shared storage space that stores the web application, and combine the downloaded content with the loaded template to complete the selected web application.

In accordance with another aspect of the present invention, a server is provided. The server includes a communication interface configured to establish communication between the server and at least one electronic device, and a processor configured to receive a web application created on a basis of a template, store the received web application in a shared storage space, receive a request for content of the web application from the at least one electronic device, and transmit the content of the web application requested by the at least one electronic device from the shared storage space to the at least one electronic device that requested the content.

In accordance with another aspect of the present invention, a non-transitory computer-readable recording medium storing a program executed by a processor in a computer to perform method is provided. The method includes loading a template of the web application, receiving an input of content corresponding to the loaded template, and combining the input content with the loaded template to create the web application.

In accordance with another aspect of the present invention, a non-transitory computer-readable recording medium storing a program executed by a processor in a computer to perform a method is provided. The method includes receiving a selection of at least one web application created on a basis of a template; loading a template of the selected web application, downloading content of the selected web application from a shared storage space that stores the web application, and combining the downloaded content with the loaded template to complete the selected web application.

### BRIEF DESCRIPTION OF THE DRAWINGS

The above and other aspects, features, and advantages of the present invention will be more apparent from the following detailed description, taken in conjunction with the accompanying drawings, in which:

FIG. 1 is a block diagram illustrating a network environment including an electronic device according to an embodiment of the present invention;

FIG. 2 is a block diagram of a server according to an embodiment of the present invention;

FIG. 3 is a block diagram of a system for processing web applications according to an embodiment of the present invention;

FIG. 4 is a block diagram of a structure of a web application according to an embodiment of the present invention;

FIG. 5 is a diagram illustrating a template of a web application according to an embodiment of the present invention;

FIG. 6 is a diagram illustrating a template of a web application according to an embodiment of the present invention;

FIG. 7 is a diagram illustrating an example of a web application template list according to an embodiment of the present invention;

FIGS. 8A to 8E illustrate an example of creating a web application on the basis of a template according to an embodiment of the present invention;

FIGS. 9A to 9D illustrate an example of creating a web application on the basis of a template according to an embodiment of the present invention;

FIG. 10 is a flowchart of a method of creating a web application by an electronic device according to an embodiment of the present invention;

FIG. 11 illustrates an example of a web application list according to an embodiment of the present invention;

FIG. 12 is a flowchart of a method of loading a web application by an electronic device according to an embodiment of the present invention;

FIG. 13 is a flowchart of a method of sharing a web application by a server according to an embodiment of the present invention;

FIG. 14 is a block diagram of an electronic device according to an embodiment of the present invention; and

FIG. 15 is a block diagram of a program module according to an embodiment of the present invention.

### DETAILED DESCRIPTION OF EMBODIMENTS OF THE PRESENT INVENTION

Hereinafter, various embodiments of the present invention are described with reference to the accompanying drawings. However, it should be understood that there is no intent to limit the present invention to particular forms, and the present invention should be construed to cover all modifications, equivalents, and/or alternatives falling within the scope and spirit of the present invention. In describing the accompanying drawings, similar reference numerals may be used to designate similar elements.

As used herein, the expressions “have,” “may have,” “include,” or “may include” refer to the existence of a corresponding feature (e.g., numeral, function, operation, or element such as a component), and do not exclude one or more additional features.

As used herein, the expressions “A or B,” “at least one of A and/or B,” or “one or more of A and/or B” may include any or all possible combinations of items enumerated together. For example, the expressions “A or B,” “at least one of A and B,” or “at least one of A or B” may include (1) at least one A, (2) at least one B, or (3) both at least one A and at least one B.

The expressions such as “first,” “second,” or the like used in various embodiments of the present invention may modify various elements regardless of their order or importance, and do not limit corresponding elements. The expressions may be used to distinguish an element from another element. For example, a first user device and a second user device indicate different user devices regardless of their order or importance. For example, a first element may be referred to as a second element, and similarly, a second element may be referred to as a first element without departing from the scope of the present invention.

It should be understood that when an element (e.g., a first element) is referred to as being (operatively or communicatively) “connected,” or “coupled,” to another element (e.g., a second element), it may be directly connected or directly coupled to the other element or another element (e.g., a third element) may be interposer between them. In contrast, it may be understood that when an element (e.g., a first element) is referred to as being “directly connected,” or “directly coupled” to another element (e.g. a second element), there are no elements (e.g., a third element) interposed between them.

As used herein, the expression “configured to” may be interchangeably used with the expression “suitable for,” “having the capability to,” “designed to,” “adapted to,” “made to,” or “capable of.” The expression “configured to” may not necessarily mean “specially designed to” in terms of hardware. Alternatively, in some situations, the expression “device configured to” may indicate that the device, together with other devices or components, “is able to.” For example, the phrase “processor adapted (or configured) to perform A, B, and C” may refer to a dedicated processor (e.g. an embedded processor) for performing only the corresponding operations or a general-purpose processor (e.g., a Central Processing Unit (CPU) or Application Processor (AP)) that can perform the corresponding operations by executing one or more software programs stored in a memory device.

As used herein, the term “specified” may include the meaning of, for example, “predetermined” or “specific” according to a situation.

The terms used herein are merely descriptive and are not intended to limit the scope of the present invention. As used herein, the singular forms may include the plural forms as well, unless the context clearly indicates otherwise. Unless defined otherwise, all terms used herein, including technical terms and scientific terms, may have the same meaning as commonly understood by a person of ordinary skill in the art to which the present invention pertains. Such terms as those defined in a generally used dictionary may be interpreted to have the meanings equal to the contextual meanings in the relevant field of art, and are not to be interpreted to have ideal or excessively formal meanings unless clearly defined in the present invention. In some cases, even the terms defined herein may not be construed to exclude embodiments of the present invention.

An electronic device according to an embodiment of the present invention, for example, may include at least one of a smartphone, a tablet Personal Computer (PC), a mobile phone, a video phone, an electronic book (e-book) reader, a desktop PC, a laptop PC, a netbook computer, a workstation, a server, a Personal Digital Assistant (PDA), a Portable Multimedia Player (PMP), a Moving Picture Experts Group Audio Layer 3 (MP3) player, a mobile medical appliance, a camera, and a wearable device (e.g., smart glasses, a Head-Mounted-Device (HMD), electronic clothes, an electronic bracelet, an electronic necklace, an electronic appcessory, an electronic tattoo, a smart mirror, or a smart watch).

According to an embodiment of the present invention, an electronic device may be a smart home appliance. The smart home appliance may, for example, include at least one of a television, a Digital Video Disk (DVD) player, an audio player, a refrigerator, an air conditioner, a cleaner, an oven, a microwave oven, a washing machine, an air purifier, a set-top box, a home automation control panel, security control panel, a TV box (e.g., HomeSync™ of Samsung, Apple TV™, or Google TV™), a game console (e.g., Xbox™, PalyStation™), an electronic dictionary, an electronic key, a camcorder, and an electronic frame.

According to an embodiment of the present invention, an electronic devices may include at least one of various medical devices (e.g., various portable medical measurement devices (e.g., a blood glucose monitor, a heart rate monitor, a blood pressure monitor, or a body temperature monitor), a Magnetic Resonance Angiography (MRA), a Magnetic Resonance Imaging (MRI), a Computed Tomography (CT) scanner, and an ultrasonic machine), navigation equipment, Global Positioning System (GPS) receivers, Event Data Recorders (EDRs), Flight Data Recorders (FDRs), vehicle infotainment devices, electronic equipment for ships (e.g., navigation equipment for ships and gyro-compasses), avionics, security devices, automotive head units, home or industry robots, Automatic Teller Machines (ATMs) in bank systems, Point of Sale (POS) terminals in shops, and the Internet of Things (IoT) devices (e.g., bulbs, various sensors, electric or gas meters, sprinklers, fire alarms, thermostats, street lamps, toasters, exercise machines, hot water tanks, heaters, or boilers).

According to an embodiment of the present invention, an electronic device may include at least one of furniture or a part of a building/structure having a communication function, electronic boards, electronic signature receiving devices, projectors, or various measuring equipment (e.g., equipment for measuring a water supply, electricity, gas or radio waves).

In an embodiment of the present invention, an electronic device may be a combination of one or more of the aforementioned various devices. According to an embodiment of the present invention, an electronic device may also be a flexible device. Also, an electronic device according to an embodiment of the present invention is not limited to the above-mentioned devices, and, with the development of technology, may include subsequently developed electronic devices.

Hereinafter, an electronic device according to an embodiment of the present invention will be described with reference to the accompanying drawings. As used herein, the term “user” may indicate a person who uses an electronic device or a device (e.g., an artificial intelligence electronic device) that uses an electronic device.

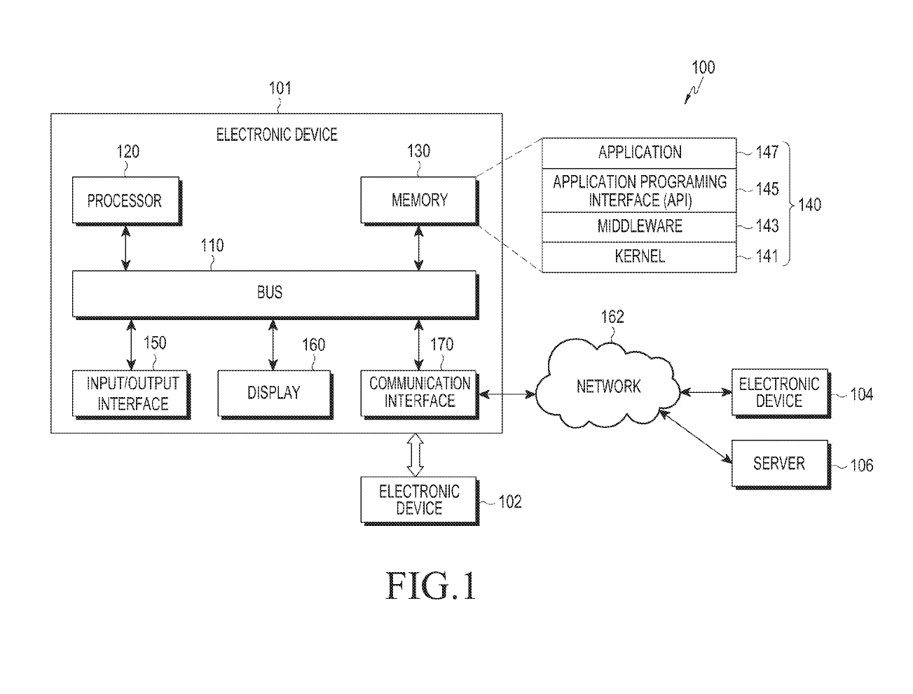

FIG. 1 is a block diagram illustrating a network environment 100 including an electronic device 101 according to an embodiment of the present invention.

Referring to FIG. 1, the electronic device 101 includes a bus 110, a processor 120, a memory 130, an input/output interface 150, a display 160, and a communication interface 170. In an embodiment of the present invention, the electronic device 101 may exclude at least one of the elements 110 to 170, or may further include other elements.

The bus 110 is a circuit for connecting elements 110 to 170 of the electronic device 101 with each other and transferring communication data (e.g., control messages and/or data) between the elements 110 to 170.

The processor 120 may include one or more of a Central Processing Unit (CPU), an Application Processor (AP), or a Communication Processor (CP). The processor 120 may perform a calculation or process data related to control and/or communication of at least one of the other elements of the electronic device 101.

The memory 130 may include a volatile memory and/or a non-volatile memory. The memory 130 stores instructions or data related to at least one of the elements of the electronic device 101. According to an embodiment of the present invention, the memory 130 includes software and/or programs 140. The programs 140 may include, for example, a kernel 141, middleware 143, an Application Programming Interface (API) 145, and/or application program (or “application”) 147. At least some of the kernel 141, the middleware 143 or the API 145 may be referred to as an operating system (OS).

The kernel 141 controls or manages system resources (e.g., the bus 110, the processor 120, the memory 130, or the like) that are used in performing operations or functions implemented by other programs (e.g., the middleware 143, the API 145 or the application programs 147). Further, the kernel 131 provides an interface by which the middleware 143, the API 145 or the application programs 147 accesses each element of the electronic device 101 for control or management of the system resources.

The middleware 143 performs an intermediate role between the API 145 or the application programs 147 and the kernel 141 to facilitate communication between each other for the transmission and reception of data. Further, in relation to requests for operations received from the application programs 147, the middleware 132 controls (e.g., performs scheduling or load-balancing) for the requests, for example, by giving priority for using system resources (e.g., the bus 110, the processor 120, the memory 130, or the like) of the electronic device 101 to at least one of the application programs 147.

The API 145 is, for example, an interface by which the applications 147 control functions provided from the kernel 141 or the middleware 143, and it may include, for example, at least one interface or function (e.g., instructions) for file control, window control, image processing, or text control.

The input/output interface 150 transfers instructions or data input by the user or external devices to other elements of the electronic device 101. For example, the input/output interface 150 may output instructions or data, which are received from other elements of the electronic device 101 to the user or other external devices.

The display 160 may include, for example, a Liquid-Crystal Display (LCD), a Light-Emitting Diode (LED) display, an Organic LED (OLED) display, a Micro-ElectroMechanical Systems (MEMS) display, or an electronic paper display. The display 160 displays, for example, various contents (e.g., text, images, videos, icons or symbols) to the user. The display 160 may include a touch screen, and may receive inputs of touches, gestures, proximity or hovering, for example, by using electronic pens or a user's body parts.

The communication interface 170 establishes communication, for example, between the electronic device 101 and external devices (e.g., the first external electronic device 102, the second external electronic device 104, or a server 106). For example, the communication interface 170 may be connected to a network 162 through wired or wireless communication to communicate with the external devices (e.g., the second external electronic device 104 or the server 106).

The wireless communication may include at least one of Wireless Fidelity (WiFi), Bluetooth (BT), Near Field Communication (NFC), a Global Positioning System (GPS), cellular communication (e.g., Long Term Evolution (LTE), LTE Advanced (LTE-A), Code Division Multiple Access (CDMA), Wideband CDMA (WCDMA), Universal Mobile Telecommunications System (UNITS), Wireless Broadband (WiBro), Global System for Mobile communications (GSM)), or the like. The wired communication may include at least one of a Universal Serial Bus (USB), a Universal Asynchronous Receiver/Transmitter (UART), a Mobile High-definition Link (MHL), a High Definition Multimedia Interface (HDMI), Recommended Standard 232 (RS-232), a Plain Old Telephone Service (POTS), or the like.

According to an embodiment of the present invention, the network 162 may include at least one of a telecommunications network such as a computer network (e.g., a Local Area Network (LAN), a Wide Area Network (WAN)), the Internet, a telephone network, or the like.

The first external electronic device 102 and the second external electronic device 104 may be the same as, or different from, the electronic device 101. According to an embodiment of the present invention, the server 106 may include one or more groups of servers. According to an embodiment of the present invention, some of or all of the operations executed in the electronic device 101 may be executed in one or more of the electronic devices 102, 104, 106. According to an embodiment of the present invention, in executing some functions or services of the electronic device 101 automatically or by a request of the user, the electronic device 101 may make a request to other electronic devices 102, 104, 106 for executing some of the functions instead of or in addition to executing the functions or services by the electronic device 101. The other electronic devices 102, 104, 106 execute the requested functions or additional functions, and transfer the results to the electronic device 101. The electronic device 101 processes the received results and provides the requested functions or services. In this case, for example, cloud computing, distributed computing, or client-server computing may be utilized.

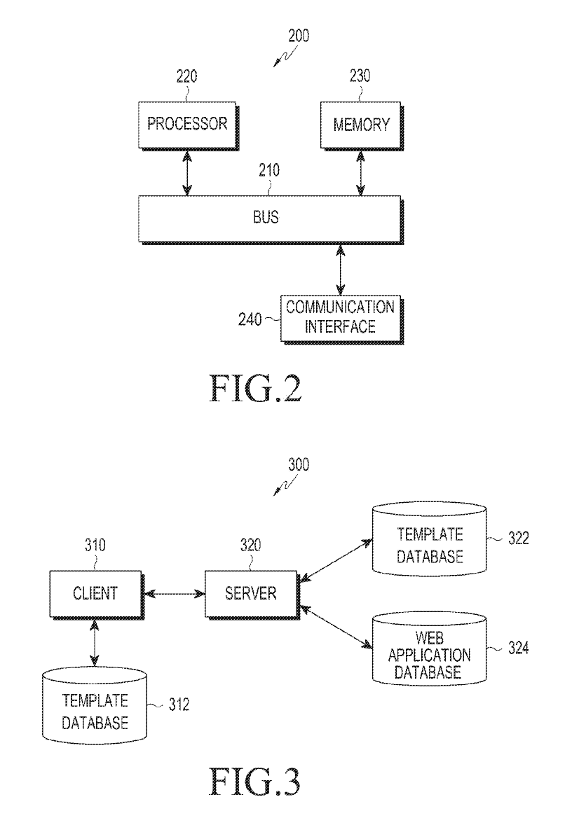

FIG. 2 is a block diagram of a server 200 according to an embodiment of the present invention.

Referring to FIG. 2, the server 200 (e.g., the server 106 of FIG. 1) includes a bus 210, a processor 220, a memory 230, and a communication interface 240.

The bus 210 is a circuit for connecting elements 220 to 240 of the server 200 with each other and transferring communication data (e.g., control messages and/or data) between the elements 220 to 240.

The processor 220 may include a Central Processing Unit (CPU). The processor 220 performs a calculation or processes data related to control and/or communication of at least one of the other elements of the server 220.

The memory 230 may include a volatile memory and/or a non-volatile memory. The memory 230 stores instructions or data related to at least one of the elements of the server 200. According to an embodiment of the present invention, the memory 230 stores software and/or programs for operating the server 200.

The communication interface 240 establishes communication, for example, between the server 200 and at least one electronic device (e.g., the electronic device 101 or the electronic device 104). For example, the communication interface 240 may be connected to the network 162 through wired or wireless communication to communicate with the electronic device.

FIG. 3 is a block diagram of a system 300 for processing a web application according to an embodiment of the present invention.

Referring to FIG. 3, the web application processing system 300 includes a client 310, a template database 312, a server 320, a template database 322, and a web application database 324. Although a single client 310 is connected to the server 320 in FIG. 3, for example, a plurality of clients identical or similar to the client 310 may be connected to the server 320.

For example, the client 310 may be the electronic device 101 of FIG. 1, and the server 320 may be the server 106 of FIG. 1 or the server 200 of FIG. 2. According to an embodiment of the present invention, the template database 312 is included in the memory 130 of the electronic device 101. According to an embodiment of the present invention, the template database 322 and the web application database 324 are included in the server 106 or the server 200. For example, the template database 322 and the web application database 324 are included in the memory 230 of the server 200. According to an embodiment of the present invention, the template database 322 and the web application database 324 are included in another server that is connected to the server 106 directly or through the network 162.

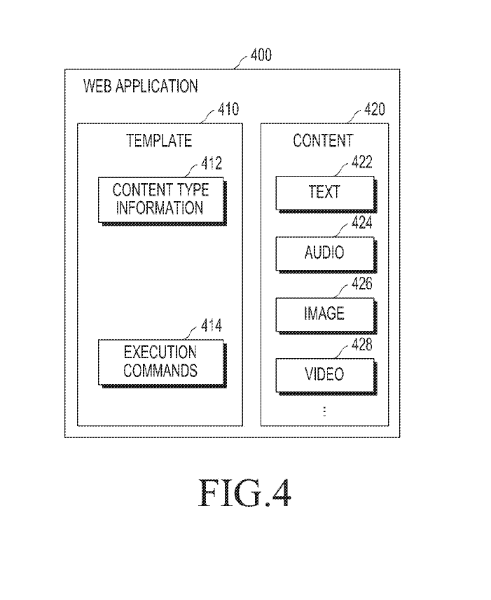

The template database 322 is a shared storage space to which a plurality of clients including the client 310 can access through the server 320. The template database 322 stores templates of web applications. A template is a web application that is created in the form of a template by a developer. The template format is described below with reference to FIG. 4.

The server 320 receives templates of web applications written by developers and stores the same in the template database 322. The server 320 gives a unique identification (ID) to each template of a web application.

The client 310 downloads at least one template of a web application selected from among the templates of web applications that are stored in the template database 322 through the server 320. The template of a web application to be downloaded may be selected by a user input to the electronic device 101. The client 310 caches a downloaded template of a web application in the template database 312 on the basis of the template ID of the downloaded template. When a template of a web application that has been cached in the template database 312 is selected, the client 310 may not download the selected template from the template database 322.

The template database 312 caches at least one template of a web application that has been downloaded by the client 310 on the basis of the template ID thereof.

The client 310 may create a web application by combining content with a template of a web application selected from the cached templates in the template database 312. The content to be combined with a template of a web application may be selected from the memory 130 by the user of the electronic device 101, or may be directly input by the user. The content stored in the memory 130 may be the content that has been input by the user of the electronic device 101 or received from external electronic devices (e.g., the first external electronic device 102, the second external electronic device 104, or the server 106). The client 310 stores a created web application in the web application database 324 through the server 320.

The web application database 324 is a shared storage space to which a plurality of clients including the client 310 can access. The web application database 324 stores a web application created on the basis of a template.

The server 320 receives a web application created on the basis of a template from the client 310 and stores the same in the web application database 324. The server 320 may receive other web applications created on the basis of templates from other clients that are identical or similar to the client 310, and stores the same in the template database 324. The server 320 gives a unique web application ID to each web application created.

The client 310 loads at least one of the web applications that are stored in the web application database 324. A web application loaded may be selected by a user input to the electronic device 101. The client 310 downloads the template of a selected web application from the template database 322 through the server 320. The client 310 caches the downloaded template in the template database 312 on the basis of the template ID of the downloaded template. When a template of a selected web application that has been cached in the template database 312 is selected, the client 310 may not download the template of the selected web application from the template database 322.

The client 310 downloads the content of a selected web application from the web application database 324 through the server 320. The client 310 loads the template of a selected web application from among templates of web applications cached in the template database 312. The client 310 completes a selected web application by combining the content downloaded from the web application database 324 with the loaded template. For example, the client 310 outputs the completed web application through the display 160.

According to an embodiment of the present invention, the client 310 caches the content downloaded from the web application database 324. The client 310 configures a database for caching the content downloaded from the web application database 324 in the memory 130. In the case of the content of the selected web application, which has been cached, the client 310 combines the cached content with the template of a selected web application instead of downloading the corresponding content.

FIG. 4 is a block diagram of a structure of the web application 400 according to an embodiment of the present invention.

Referring to FIG. 4, the web application 400 includes a template 410 and a content 420. The template 410 includes content type information 412 and execution commands 414.

The content type information 412 indicates at least one type of content and a number of contents, which are defined in the template 410 by a developer thereof. The type of content or the number of contents, which are required for the web application 400, may be defined in the template 410 by a developer. The template 410 may be created in the defined type that is defined in the web application 400 or in an undefined type. Content of a defined type includes the type of content defined in the web application 400. According to an embodiment of the present invention, the type of defined content includes text content, image content, audio content, and video content. The undefined type of content includes a type of content that is used in the template 410 by the developer of the template 410 and is different than the defined type of content.

The execution commands 414 are execution commands for executing the web application 400 by using the content that is combined with the template 410 according to at least one of a defined type and an undefined type, which is used to create the template 410. The execution commands 414 include code such as HTML, JS, and CSS. The execution commands 414 include execution commands which are defined in the web application 400 to execute the web application 400 by using the content of the defined type. In the case of creating the template 410 by using an undefined type, a developer of the template 410 writes execution commands 414 to execute the web application 400 by using the content of the undefined type. In the case of creating the template 410 by using a defined type and an undefined type, the developer of the template 410 adds execution commands for executing the web application 400 by using the content of the undefined type to the execution commands defined in the web application 400, to thereby write the execution commands 414.

The execution commands 414 include execution commands for defining at least one of various content output types such as a static type, a dynamic type, or a user interactive type. In this case, the execution commands 414 are written to allow the web application 400 to execute a function of outputting the content 420 in at least one of various content output types such as a static type, a dynamic type, or a user interactive type. For example, the static type may display still image. For example, the dynamic type displays images in the manner of a slide show, visual effect, or the like. For example, the visual effect may include the effect of fireworks, flames, or the like. For example, the user interactive type includes the type by which the content for voting or rating is displayed to allow users to vote on or rate the content.

The content 420 includes at least one content, for example, text content 422, audio content 424, image content 426, and video content 428, which are defined in the content type information 412. The template 410 is combined with the content 420 to create the web application 400.

According to an embodiment of the present invention, an electronic device may include a memory configured to store a template of a web application; and a processor configured to load the template of the web application, receive an input of content corresponding to the template, and combine the input content with the loaded template to create the web application.

According to an embodiment of the present invention, the processor receives a selection of the template of at least one web application, loads the selected template that has been cached when the selected template has been cached in the memory, downloads the selected template from a shared storage space that stores the template of the web application when the selected template has not been cached in the memory, caches the downloaded template, and loads the downloaded template.

According to an embodiment of the present invention, the processor stores the created web application in the shared storage space.

According to an embodiment of the present invention, the template includes content type information indicating at least one type of content and a number of contents, which are defined in the template, and the processor identifies the content type information included in the template, and provides a user interface for receiving an input of content on the basis of the content type information.

According to an embodiment of the present invention, the template is created in at least one of a defined type that is defined in the web application or an undefined type. The type of content includes the type of content according to at least one of the defined type or the undefined type. The defined type of content includes the type of content that is defined in the web application, and the undefined type of content includes the type of content that is used in the template and is different than the defined type of content.

According to an embodiment of the present invention, the template includes execution commands for defining at least one content output type as a static type, a dynamic type, or a user interactive type.

According to an embodiment of the present invention, an electronic device includes a memory configured to store a template of a web application, and a processor configured to receive a selection of at least one web application created on the basis of a template, load a template of the selected web application, download content of the selected web application from a shared storage space that stores the web application, and combine the downloaded content with the loaded template to complete the selected web application.

According to an embodiment of the present invention, the processor, loads the selected template that has been cached when the selected template has been cached, downloads the template of the selected web application from the shared storage space that storing the template of the web application when the selected template has not been cached, caches the downloaded template, and loads the downloaded template.

According to an embodiment of the present invention, a server includes a communication interface configured to establish communication between the server and at least one electronic device, and a processor configured to receive the web application created on the basis of a template, store the received web application in a shared storage space, receive a request for content of the web application from the electronic device, and transmit the content of the web application requested by the electronic device from the shared storage space to the electronic device.

FIG. 5 is a diagram illustrating a template 500 of a web application according to an embodiment of the present invention.

Referring to FIG. 5, the template 500 of the web application is a template of the defined type. The template 500 includes three images and four text segments among the content of the defined type, for example, text content, image content, audio content, and video content. In this case, in the content type information of the template 500, the type of content may be images and text, and the number of contents are “three images” and “four text segments.” The template 500 includes three image input boxes 510, 512 and 514, and four text input boxes 520, 522, 524 and 526. The template 500 may be combined with three images input into three image input boxes 510, 512 and 514, and four text segments input into four text input boxes 520, 522, 524 and 526.

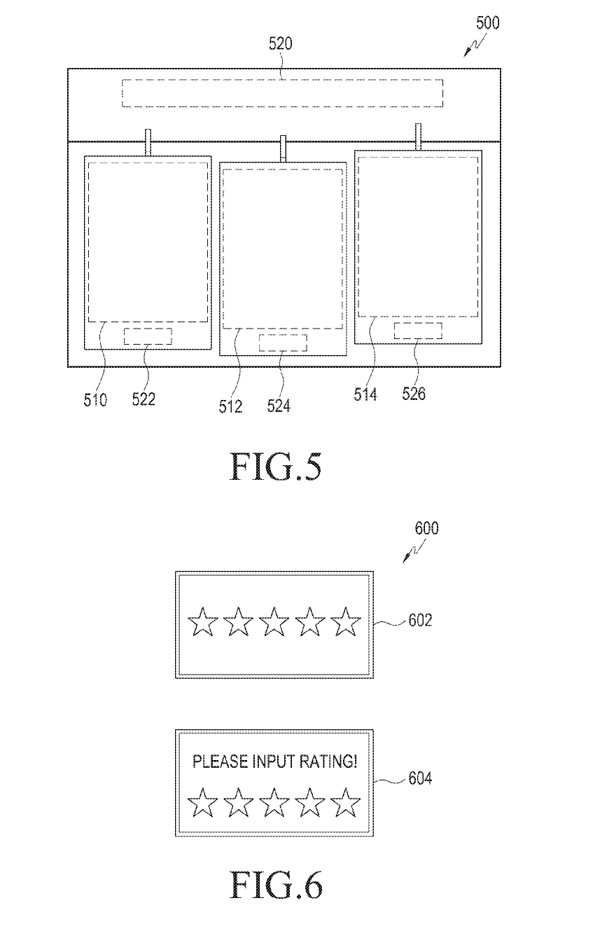

FIG. 6 is a diagram illustrating a template 600 of a web application according to an embodiment of the present invention.

Referring to FIG. 6, the template 600 of the web application is a template of the defined type and the undefined type. The template 600 is a web application template that uses one content of the defined type, for example, text content, image content, audio content, and video content, and a rating input of the undefined type. In this case, in the content type information of the template 600, the type of content includes images and a rating input, and the number of contents include “one image” and “one rating input.” The template 600 includes one image input box 602 and one rating input box 604. The template 600 may be combined with one image input into the one image input box 602, and one rating input into the one rating input box 604.

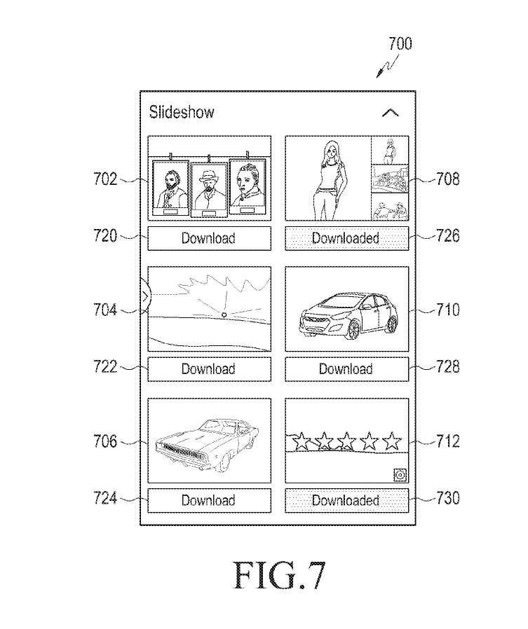

FIG. 7 is a diagram illustrating an example of the web application template list 700 according to an embodiment of the present invention.

Referring to FIG. 7, the web application template list 700 is displayed on the display 160 of the electronic device 101. For example, the template list 700 shows the list of the web application templates that perform a slide show. The template list 700 includes preview images 702 to 712, and download buttons 720 to 730. The preview images 702 to 712 show the form of each template that can be displayed on a screen at once among the templates stored in the template database 322 of the server 320. The user may scroll through the template list 700 to view the preview images of other templates. The download buttons 720 to 730 correspond to preview images 702 to 712. The download buttons 720 to 730 are used to select the templates of the preview images 702 to 712 corresponding thereto by the user to allow the electronic device 101 to download the same.

The user of the electronic device 101 selects at least one template with reference to the preview images 702 to 712 to create the web application. For example, the user of the electronic device 101 touches the download button of the preview image corresponding to the template required to create the web application from among the preview images 702 to 712 in the template list 700, to thereby select the desired template. The electronic device 101 downloads the template selected by the user from the template database 322 through the server 320.

The download buttons 720, 722, 724, 728 that are labelled “download” denote the download buttons of templates that have not been downloaded yet, and the download buttons 726, 730 that are labelled “downloaded” denote the download buttons of templates that have already been downloaded.

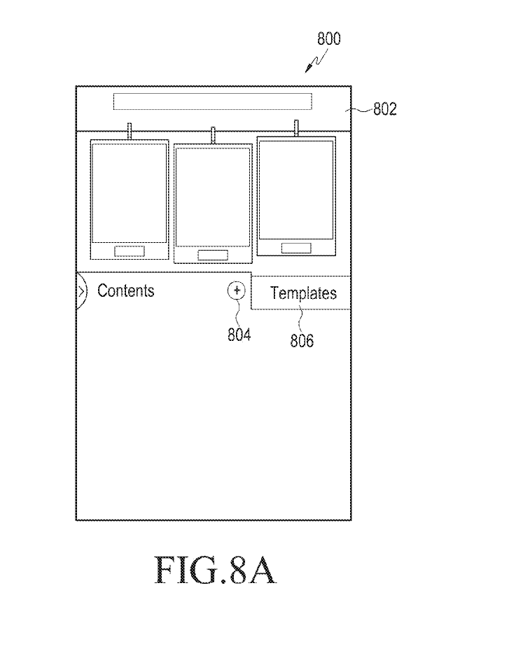

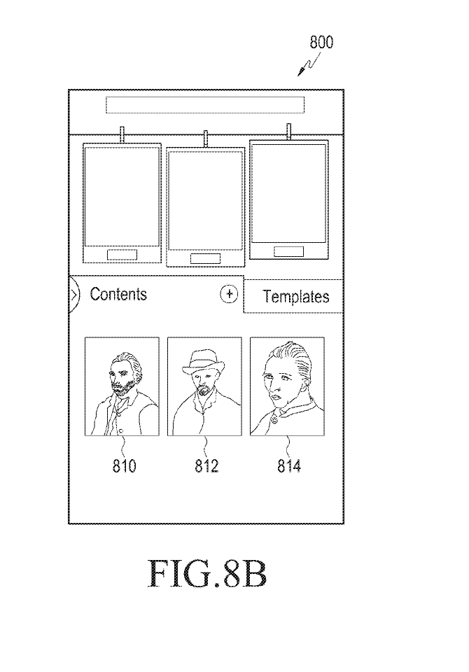

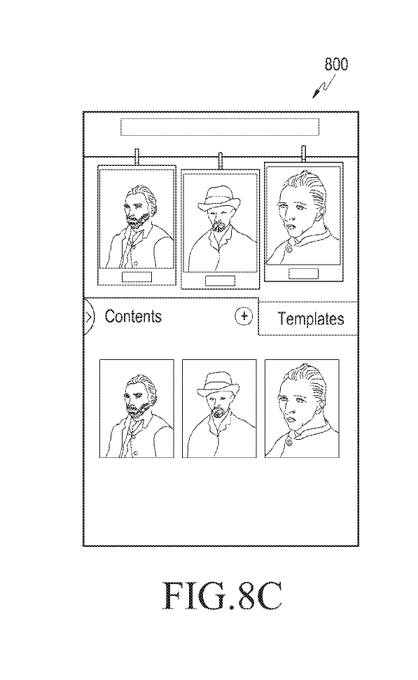

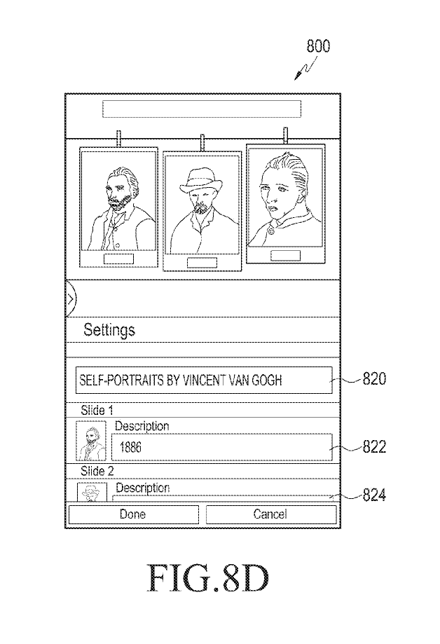

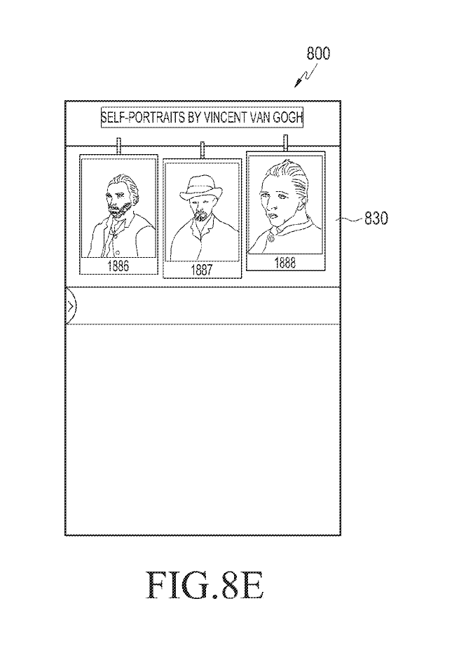

FIGS. 8A to 8E illustrate an example of creating a web application on the basis of templates according to an embodiment of the present invention.

Referring to FIG. 8A, when a user of an electronic device selects, for example, a template corresponding to the preview image 702 in the template list 700 of FIG. 7, the electronic device provides a user interface 800 as shown in FIG. 8A. The user interface 800 is displayed on the display of the electronic device.

The user interface 800 includes a template 802, a content addition button 804, and a template identification button 806. The template 802 includes the content type information as the template 500 described above in FIG. 5. The content addition button 804 is used to select the content to be combined with the template 802 from among the content stored in the electronic device. For example, a user touches the content addition button 804 to open an image storage folder like a gallery, and selects images. The template identification button 806 allows the user to identify the templates that have been downloaded and cached in the electronic device. For example, when the user touches the template identification button 806, the electronic device displays the templates that have been cached in the template database 312.

Referring to FIG. 8B, for example, in the case in which the user selects three images from the content stored in the electronic device, the electronic device displays the selected images 810 to 814 in the user interface 800. In order to combine the images 810 to 814 with the template 802, the user touches the images 810 to 814.

Referring to FIG. 8C, when the user selects the images 810 to 814 to be combined with the template 802, the electronic device displays the user interface 800 with the images 810 to 814 inputted in the image input boxes.

Referring to FIG. 8D, when the images 810 to 814 are inputted into the image input boxes, the electronic device displays the text input windows 820 to 824 in the user interface 800. The user inputs text through the text input windows 820 to 824. Although four texts are to be combined with the template 800, FIG. 8D shows only three text input windows 820 to 824. However, when the user scrolls up on the screen, another text input windows appears from the bottom.

Referring to FIG. 8E, when the input of the images and texts, which are to be combined with the template 802, is complete, the electronic device displays the template 830 with the images and texts input in the user interface 800. For example, when the input images are self-portraits of Vincent van Gogh, the web application created based on the template 830 displays the self-portraits of Vincent van Gogh using the slide show. The template 830 shows three input images, i.e., the self-portraits of Vincent van Gogh, and the input texts, i.e., “SELF-PORTRAITS BY VINCENT VAN GOGH,” and years of “1886,” “1887,” and “1888.”

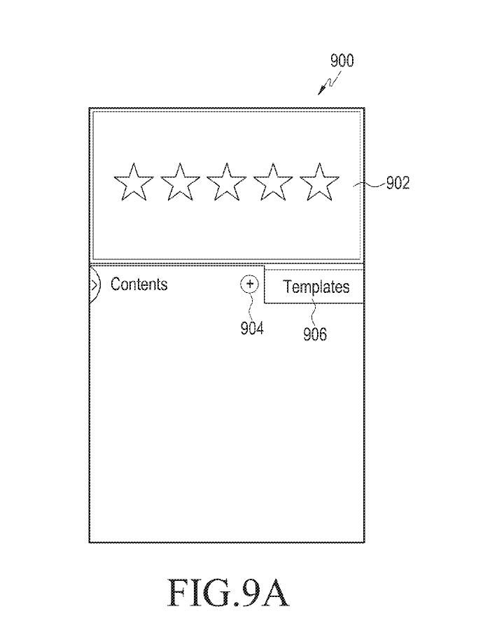

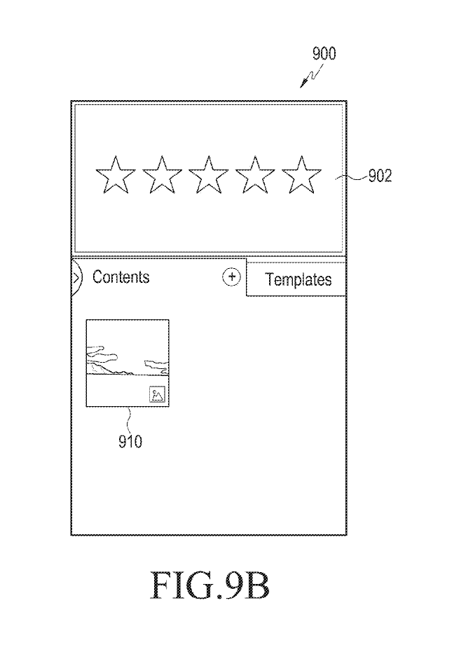

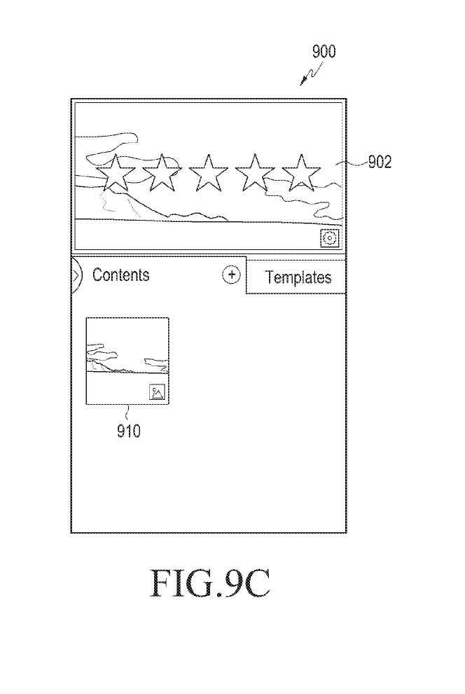

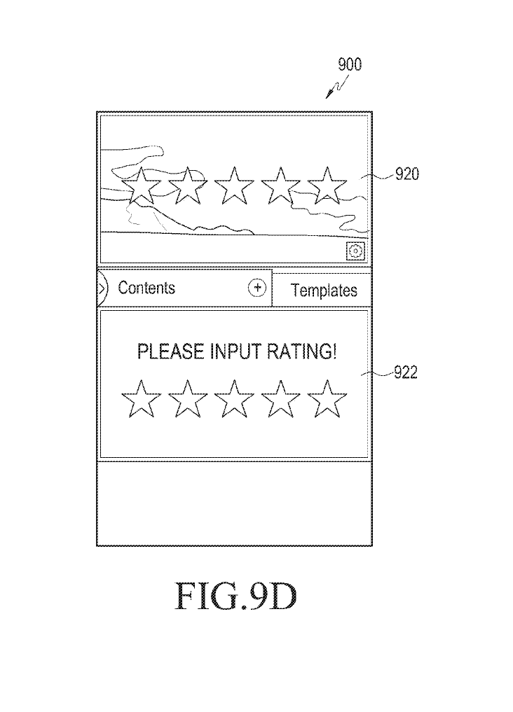

FIGS. 9A to 9D illustrate an example of creating a web application on the basis of a template according to an embodiment of the present invention.

Referring to FIG. 9A, for example, when a user of an electronic device selects a template corresponding to the preview image 712 in the template list 700 of FIG. 7, the electronic device provides a user interface 900 as shown in FIG. 9A. The user interface 900 is displayed on the display of the electronic device.

The user interface 900 includes a template 902, a content addition button 904, and a template identification button 906. The template 902 includes the content type information of the template 600 of FIG. 6. The content addition button 904 and the template identification button 906 may be the same as the content addition button 804 and the template identification button 806 in FIG. 8A.

Referring to FIG. 9B, for example, in the case in which the user selects one image from the content stored in the electronic device, the electronic device displays the selected image 910 in the user interface 900. In order to combine the image 910 with the template 902, the user touches the image 910. For example, the image 910 represents the content (e.g., movies, books, or the like) to be rated.

Referring to FIG. 9C, when the user selects the image 910 to be combined with the template 902, the electronic device displays the user interface 900 with the image 910 inputted therein.

Referring to FIG. 9D, when the input of the image 910, which is combined with the template 902, is complete, the electronic device displays the template 920 having the image 910 inputted therein and the rating input window 922 in the user interface 900. The user inputs a rating of the content through the rating input window 922.

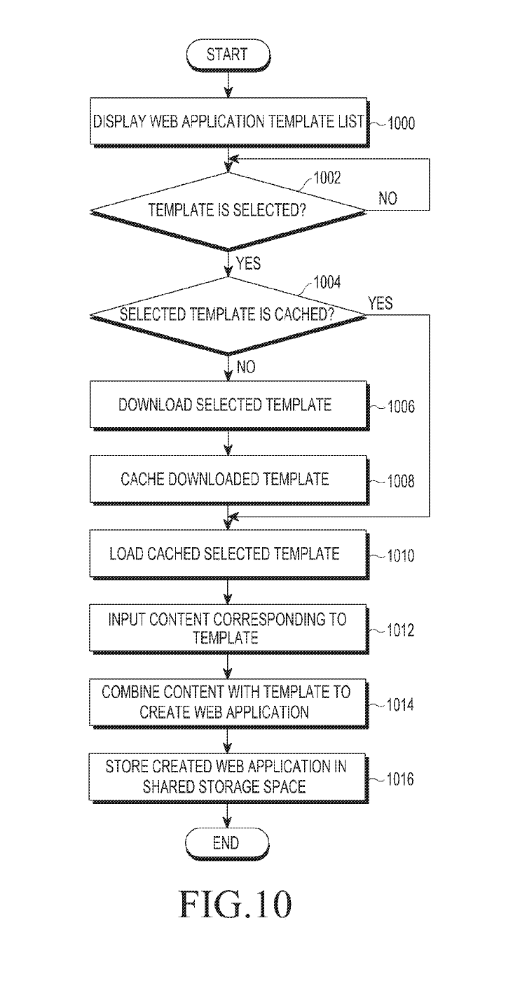

FIG. 10 is a flowchart of a method of creating a web application by an electronic device according to an embodiment of the present invention.

Referring to FIG. 10, the electronic device displays the web application template list (e.g., template list 700) in step 1000, and waits for a user's selection of a template in step 1002. According to an embodiment of the present invention, step 1000 may be performed through menus or icons that are configured to allow the user to start creating the web application.

When one template is selected by the user in step 1002, the electronic device determines whether or not the selected template has been cached in the electronic device in step 1004. According to an embodiment of the present invention, the electronic device determines whether or not the selected template has been cached in the template database 312. When the selected template has been cached in the template database 312, the electronic device performs step 1010. When the selected template has not been cached in the template database 312, the electronic device downloads the selected template from the shared storage space in step 1006. According to an embodiment of the present invention, the shared storage space is the template database 322, and the electronic device downloads the selected template from the template database 322 through the server 320. Then, the electronic device transmits the ID of the selected template to the server 320 to request the template corresponding to the selected template ID.

In step 1008, the electronic device caches the downloaded template in the electronic device. According to an embodiment of the present invention, the electronic device caches the downloaded template in the template database 312.

In step 1010, the electronic device loads the selected template from among the templates cached in the template database 312. In step 1010, the electronic device identifies the content type information included in the selected template. The electronic device provides the user interface (e.g., user interface 800 or 900) for receiving the input of the content, based on the identified content type information.

In step 1012, the electronic device inputs the content corresponding to the template. For example, the content corresponding to the template is input as described in FIGS. 8A to 8E, or FIGS. 9A to 9D.

In step 1014, the electronic device creates the web application by combining the input content with the template. The input content may be copied in the storage route of the web application. For example, the created web application may have the same structure as that of the web application 400 of FIG. 4.

In step 1016, the electronic device stores the created web application in the shared storage space. For example, the shared storage space is the web application database 324, and the electronic device stores the created web application in the web application database 324 through the server 320. Therefore, the web application created by the user using the electronic device may be retrieved and executed by other users.

According to an embodiment of the present invention, a method for processing a web application in an electronic device includes loading a template of the web application; receiving an input of content corresponding to the loaded template; and combining the input content with the loaded template to create the web application.

According to an embodiment of the present invention, the step of loading the template includes receiving a selection of the template of at least one web application; determining whether or not the selected template has been cached; loading the selected template when the selected template has been cached; downloading the selected template from a shared storage space that storing the template of the web application when the selected template has not been cached; caching the downloaded template; and loading the downloaded template.

According to an embodiment of the present invention, the method of processing a web application in an electronic device includes storing a created web application in a shared storage space.

According to an embodiment of the present invention, the template includes content type information indicating at least one type of content and a number of contents, which are defined in the template, and loading the template includes identifying the content type information included in the template; and providing a user interface for receiving an input of content on the basis of the content type information.

According to an embodiment of the present invention, a template is created in at least one of a defined type that is defined in a web application or an undefined type. The type of content includes the type of content according to at least one of the defined type or the undefined type. The defined type of content includes the type of content that is defined in the web application, and the undefined type of content includes the type of content that is used in the template and is different than the defined type.

According to an embodiment of the present invention, the template includes execution commands for defining at least one content output type as a static type, a dynamic type, or a user interactive type.

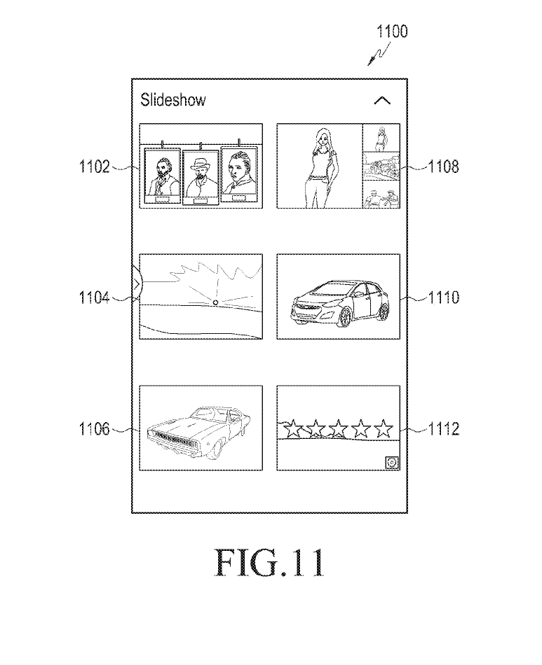

FIG. 11 illustrates an example of a web application list according to an embodiment of the present invention.

Referring to FIG. 11, the web application list 1100 is displayed on the display 160 of the electronic device 101. For example, the web application list 1100 displays the list of web applications that performs a slide show. The web application list 1100 includes the preview images 1102 to 1112. The preview images 1102 to 1112 show representations of each of the web applications stored in the web application database 324, which can be displayed in a screen at once. A user scrolls the web application list to view the preview image of another web application.

The user of the electronic device selects at least one web application that the user wishes to execute from among the preview images 1102 to 1112. For example, the user of the electronic device touches the preview image corresponding to the web application that the user wants from among the preview images 1102 to 1112, to thereby select the same.

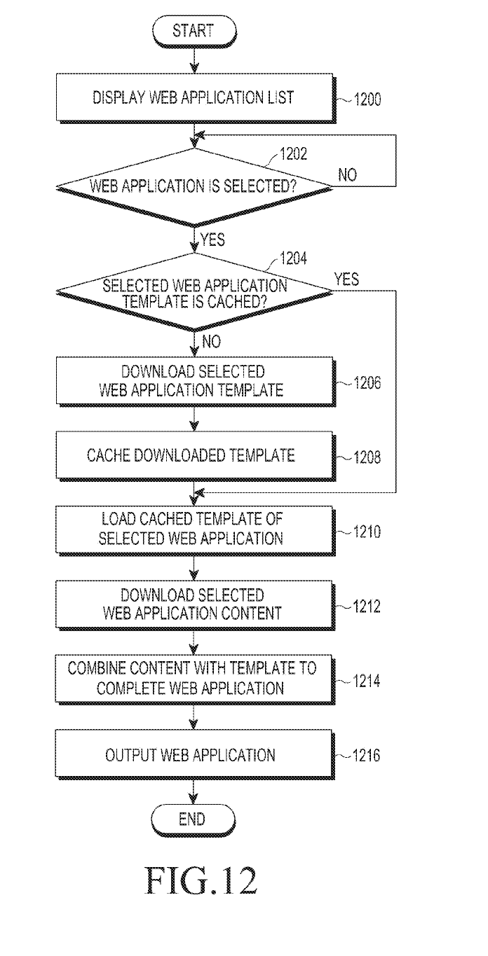

FIG. 12 is a flowchart of a method of loading a web application by an electronic device according to an embodiment of the present invention.

Referring to FIG. 12, the electronic device displays the web application list (e.g., web application list 1100) in step 1200, and waits for the user's selection for the web application in step 1202. Step 1200 may be performed through menus or icons that are configured to allow the user to select the web application.

When one web application is selected by the user in step 1202, the electronic device determines whether or not the template of the selected web application has been cached in the electronic device in step 1204. According to an embodiment of the present invention, the electronic device determines whether or not the template of the selected web application has been cached in the template database 312. When the template of the selected web application has been cached in the template database 312, the electronic device performs step 1210. When the template of the selected web application has not been cached in the template database 312, the electronic device downloads the template of the selected web application from the shared storage space in step 1206. According to an embodiment of the present invention, the shared storage space is the template database 322, and the electronic device downloads the template of the selected web application from the template database 322 through the server 320. Then, the electronic device transmits the ID of the selected template to the server 320 to request the template corresponding to the selected template ID.

In step 1208, the electronic device caches the downloaded template in the electronic device. According to an embodiment of the present invention, the electronic device caches the downloaded template in the template database 312.

In step 1210, the electronic device loads the template of selected web application from among the templates cached in the template database 312.

In step 1212, the electronic device downloads the content of the selected web application from the shared storage space. For example, the shared storage space is the web application database 324, and the electronic device downloads the content of the selected web application from the web application database 324 through the server 320. Then, the electronic device transmits the ID of the selected web application to the server 320 to thereby make a request to the server 320 for the content of the selected web application.

In step 1214, the electronic device combines the downloaded content with the template to complete the web application. For example, the completed web application may have the same structure as that of the web application 400 of FIG. 4.

In step 1216, the electronic device outputs the completed web application.

According to an embodiment of the present invention, a method for processing a web application in an electronic device includes receiving a selection of at least one web application created on the basis of a template; loading a template of the selected web application; downloading content of the selected web application from a shared storage space that stores the web application; and combining the downloaded content with the loaded template to complete the selected web application.

According to an embodiment of the present invention, loading the template includes determining whether or not the template of the selected web application has been cached; loading the selected template when the selected template has been cached; downloading the template of the selected web application from the shared storage space that stores the template of the web application when the selected template has not been cached; caching the downloaded template; and loading the downloaded template.

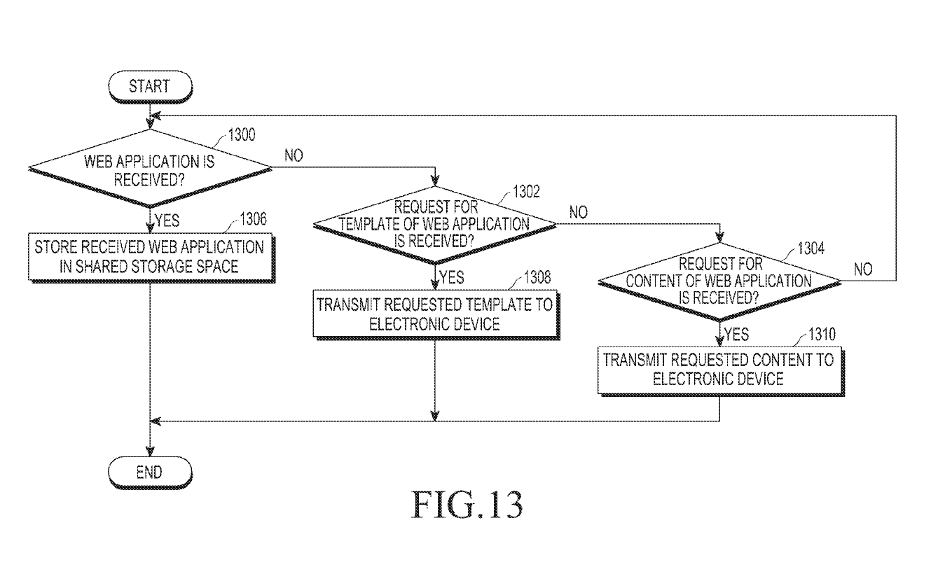

FIG. 13 is a flowchart of a method of sharing a web application by a server according to an embodiment of the present invention.

Referring to FIG. 13, the server determines whether or not the web application is received from the electronic device in step 1300. When the web application is not received from the electronic device in step 1300, the server determines whether a request for the web application template is received from the electronic device in step 1302. When the request for the web application template is not received from the electronic device in step 1302, the server determines whether or not a request for the content of the web application is received from electronic device in step 1304. When the request for the content of the web application is not received from electronic device in step 1304, the server returns to step 1300.

When the web application is received from the electronic device in step 1300, the server stores the web application received from the electronic device in the shared storage space in step 1306. According to an embodiment of the present invention, the shared storage space is the web application database 324, and the server stores the received web application in the web application database 324.

When the request for the web application template is received from the electronic device in step 1302, the server retrieves the template requested by the electronic device from the shared storage space to thereby transmit the same to the electronic device in step 1308. According to an embodiment of the present invention, the shared storage space is the template database 322, and the server retrieves the template requested by the electronic device from the template database 322. According to an embodiment of the present invention, the server retrieves the template requested by the electronic device from the template database 322 by using the template ID received from the electronic device.

When the request for the content of the web application is received from electronic device in step 1304, the server retrieves the web application content requested by the electronic device from the shared storage space to thereby transmit the same to the electronic device in step 1310. According to an embodiment of the present invention, the shared storage space is the web application database 324, and the server retrieves the web application content requested by the electronic device from the web application database 324 by using the web application ID received from the electronic device.

According to an embodiment of the present invention, a method of processing a web application in a server includes receiving a web application created on the basis of a template, storing the received web application in a shared storage space, receiving a request for content of the web application from an electronic device, and transmitting the content of the web application requested by the electronic device from the shared storage space to the electronic device.

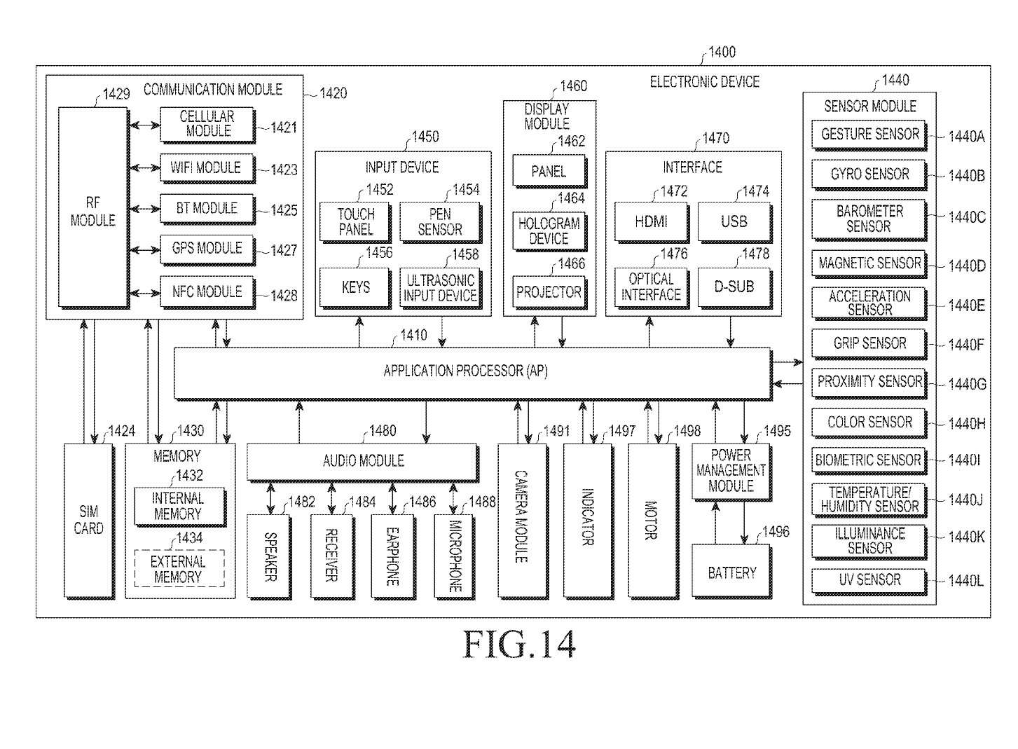

FIG. 14 is a block diagram of an electronic device 1400 according to an embodiment of the present invention.

Referring to FIG. 14, the electronic device 1400 includes a part, or all, of the electronic device 101 shown in FIG. 1. The electronic device 1400 includes at least one Application Processor (AP) 1410, a communication module 1420, a Subscriber Identification Module (SIM) card 1424, a memory 1430, a sensor module 1440, an input device 1450, a display module 1460, an interface 1470, an audio module 1480, a camera module 1491, a power management module 1495, a battery 1496, an indicator 1497, or a motor 1498.

The AP 1410 controls a multitude of hardware or software elements connected to the AP 1410 and performs data processing and calculations in an operating system or in application programs. The AP 1410 may be implemented by, for example, on a System on Chip (SoC). According to an embodiment of the present invention, the AP 1410 may include a Graphics Processing Unit (GPU) and/or an image signal processor. The AP 1410 includes at least some (e.g., cellular module 1421) of the elements shown in FIG. 14. The AP 1410 loads instructions or data received from at least one of the other elements in the volatile memory in the memory 1430 to be processed, and stores data in the non-volatile memory.

The communication module 1420 may have an identical or similar configuration to the communication interface 170 of FIG. 1. The communication module 1420 includes a cellular module 1421, a Wi-Fi module 1423, a BT module 1425, a GPS module 1427, an NFC module 1428, a Radio Frequency (RF) module 1429, or the like.

The cellular module 1421 provides services of voice calls, video calls, text messages, or Internet services through communication networks. For example, the cellular module 1421 performs identification and authentication of the electronic device 1400 in communication networks by using SIM cards 1424. According to an embodiment of the present invention, the cellular module 1421 performs at least some of the functions provided by the AP 1410. According to an embodiment of the present invention, the cellular module 1421 includes a Communication Processor (CP).

Each of the Wi-Fi module 1423, the BT module 1425, the GPS module 1427, and the NFC module 1428 may include, for example, a processor for processing data transmitted and received through each module. According to an embodiment of the present invention, at least some (e.g., two or more) of the cellular module 1421, the Wi-Fi module 1423, the BT module 1425, the GPS module 1427, or the NFC module 1428 may be included in one integrated circuit (IC) or in one IC package.

The RF module 1429 transmits and receives communication signals (e.g., RF signals). The RF module 1429 includes, for example, transceivers, Power Amplifier Modules (PAM), frequency filters, Low Noise Amplifiers (LNA), or antennas. According to an embodiment of the present invention, at least one of the cellular module 1421, the Wi-Fi module 1423, the BT module 1425, the GPS module 1427, and the NFC module 1428 transmits and receives RF signals through separate modules.

The SIM card 1424 includes a card adopting a Subscriber Identification Module and/or an embedded SIM, and includes unique identification information (e.g., an Integrated Circuit Card Identifier (ICCID)) or subscriber information (e.g., an International Mobile Subscriber Identity (IMSI)).

The memory 1430 includes, for example, an internal memory 1432 or an external memory 1434. The internal memory 1432 includes at least one of volatile memories (e.g., Dynamic Random Access Memory (DRAM), Static RAM (SRAM), Synchronous Dynamic RAM (SDRAM), or the like) or non-volatile Memories (e.g., One Time Programmable Read Only Memory (OTPROM), Programmable ROM (PROM), Erasable and Programmable ROM (EPROM), Electrically Erasable and Programmable ROM (EEPROM), mask ROM, flash ROM, NAND flash memory, NOR flash memory, or the like), hard drives, a Solid-State Drive (SSD), or the like.

The external memory 1434 may include a flash drive, for example, a Compact Flash (CF), a Secure Digital (SD) memory card, a Micro Secure Digital (Micro-SD) memory card, a Mini Secure Digital (Mini-SD) memory card, an extreme Digital (xD) memory card, a Memory Stick, or the like. The external memory 1434 may be functionally and/or physically connected to the electronic device 1400 through various interfaces.

The sensor module 1440 measures physical quantities and detects an operation state of the electronic device 1400, to thereby convert the measured or detected information to electrical signals. The sensor module 1440 includes, for example, at least one of a gesture sensor 1440A, a gyro-sensor 1440B, an barometer sensor 1440C, a magnetic sensor 1440D, an acceleration sensor 1440E, a grip sensor 1440F, a proximity sensor 1440G a color sensor 1440H (e.g., Red-Green-Blue (RGB) sensor), a biometric sensor 1440I, a temperature/humidity sensor 1440J, an illuminance sensor 1440K, or an Ultra Violet (UV) light sensor 1440L. Alternatively or additionally, the sensor module 1440 may include an Electronic-nose (E-nose) sensor, an ElectroMyoGraphy sensor (EMG), an ElectroEncephaloGram sensor (EEG), an ElectroCardioGram sensor (ECG), an InfraRed (IR) sensor, an iris sensor, a fingerprint sensor, or the like. The sensor module 1440 may include a control circuit for controlling at least one sensor included in the sensor module 1440. In an embodiment of the present invention, the electronic device 1400 may include a processor for controlling the sensor module 1440, as a part of the AP 1410 or separately from the AP 1410, to thereby control the sensor module 1440 even while the AP 1410 is in a reduced power consumption or sleep mode.

The input device 1450 may include a touch panel 1452, a (digital) pen sensor 1454, keys 1456, or an ultrasonic input device 1458. The touch panel 1452 recognizes a touch input by at least one of, for example, a capacitive type panel, a pressure type panel, an infrared type panel, or an ultrasonic type panel. In addition, the touch panel 1452 may further include a control circuit. In a case of a capacitive type panel, proximity as well as direct touches may be detected. The touch panel 1452 may further include a tactile layer to provide the user with a tactile reaction.

The (digital) pen sensor 1454 may be a part of the touch panel 1452 or may include a separate recognition sheet. The keys 1456 may include, for example, physical buttons, optical keys, or a keypad. The ultrasonic input device 1458 detects acoustic waves with a microphone (e.g., microphone 1488) at the electronic device 1400 through an input means that generates ultrasonic signals to thereby identify data.

The display module 1460 (e.g., display 160) may include a panel 1462, a hologram device 1464, or a projector 1466. The panel 1462 may have a identical or similar configuration to the display 160 of FIG. 1. The panel 1462 may be implemented to be, for example, flexible, transparent or wearable. The panel 1462 may be configured with the touch panel 1452 as a single module. The hologram device 1464 display 3D images in the air by using the interference of light. The projector 1466 displays images by projecting light onto a screen. The screen may be positioned, for example, internal or external to the electronic device 1400. According to an embodiment of the present invention, the display module 1460 may further include a control circuit for controlling the panel 1462, the hologram device 1464, or the projector 1466.

The interface 1470 may include, for example, a High-Definition Multimedia Interface (HDMI) 1472, a Universal Serial Bus (UBS) 1474, an optical interface 1476, or a D-subminiature (D-sub) connector 1478. The interface 1470 may be included in, for example, the communication interface 170 shown in FIG. 1. Additionally or alternatively, the interface 1470 may include, for example, a Mobile High-definition Link (MHL) interface, a Secure Digital (SD) card/MultiMedia Card (MMC) interface or an InfraRed Data Association (IrDA) standard interface.

The audio module 1480, for example, converts voice to electrical signals, and vice versa. At least some elements of the audio module 1480 may be included in, for example, the input/output interface 150 shown in FIG. 1. The audio module 1480 may process voice information input or output through, for example, a speaker 1482, a receiver 1484, an earphone 1486 or a microphone 1488.

The camera module 1491 is a device for photographing still and moving images, and includes at least one image sensor (e.g., a front sensor or a rear sensor), lenses, an Image Signal Processor (ISP), or a flash (e.g., a Light Emitting Diode (LED) or a xenon lamp) according to an embodiment of the present invention.

The power management module 1495 manages power of the electronic device 1400. According to an embodiment of the present invention, the power management module 1495 may include, for example, a Power Management Integrated Circuit (PMIC), a charger Integrated Circuit (IC), or a battery gauge. The PMIC may be divided into a wired type and a wireless type. The wireless charging type may encompass, for example, a magnetic resonance type, a magnetic induction type or an electromagnetic wave type, and additional circuits for wireless charging, for example, coil loops, resonance circuits, rectifiers, or the like may be added. The battery gauge measures, for example, the remaining amount of electrical power in the battery 1496, a charging voltage and current, or temperature. The battery 1496 may be, for example, a rechargeable battery or a solar battery.

The indicator 1497 displays a state, for example, a booting state, a message state or a charging state of the whole or a part (e.g., the AP 1410) of the electronic device 1400. The motor 1498 converts electrical signals to mechanical vibrations, and may perform vibration or haptic functions. The electronic device 1400 may include a processing device (e.g., a GPU) for supporting mobile TV. The processing device for supporting mobile TV may process media data according to standards such as, for example, a Digital Multimedia Broadcasting (DMB), a Digital Video Broadcasting (DVB) or a media flow.

Each of the elements of the electronic device 1400 according to the present invention may be implemented by one or more components and the name of the corresponding element may vary depending on a type of the electronic device 1400. The electronic device 1400 may include at least one of the above-described elements, and some elements may be omitted or an additional element may be added. Further, some of the elements of the electronic device 1400 according to an embodiment of the present invention may be combined to form a single entity, and thus, may equivalently execute functions of the corresponding elements prior to the combination.

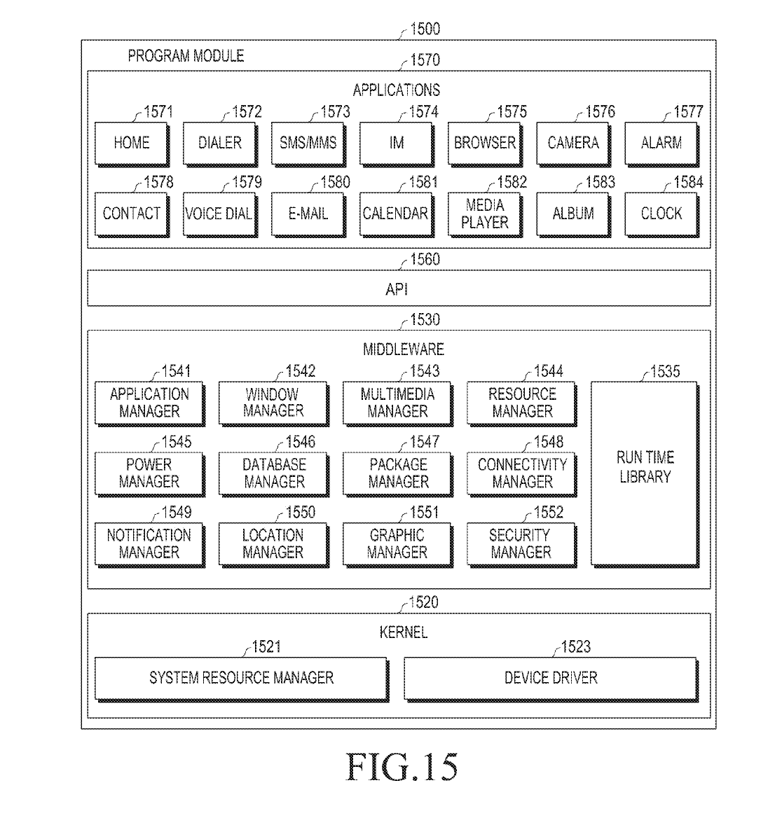

FIG. 15 is a block diagram of a program module 1500 according to an embodiment of the present invention.

Referring to FIG. 15, according to an embodiment of the present invention, the programming module 1500 (e.g., program 140) may include an Operating System (OS) for controlling resources related to the electronic device 101 and/or various applications (e.g., application program 147) that are executed under the operating system. For example, the operating system may be Android, iOS, Windows®, Symbian, Tizen™, Bada, or the like.

The programming module 1500 may include a kernel 1520, a middleware 1530, an Application Programming Interface (API) 1560, and/or applications 1570. At least some of the program module 1500 may be pre-loaded in the electronic device 101, or may be downloaded from the server 106.

The kernel 1520 (e.g., kernel 141) may include, for example, a system resource manager 1521 or a device driver 1523. The system resource manager 1521 performs the control, allotment or collection of the system resources. According to an embodiment of the present invention, the system resource manager 1521 may include a process management unit, a memory management unit, or a file system management unit. The device driver 1523 may include, for example, a display driver, a camera driver, a Bluetooth driver, a shared memory driver, a USB driver, a keypad driver, a Wi-Fi driver, an audio driver, or an Inter-Process Communication (IPC) driver.

The middleware 1530 provides functions required for the applications 1570, or may provide various functions to the applications 1570 through the API 1560 in order to allow the applications 1570 to effectively use limited system resources in the electronic device. According to an embodiment of the present invention, the middleware 1530 (e.g., middleware 143) may include at least one of a run time library 1535, an application manager 1541, a window manager 1542, a multimedia manager 1543, a resource manager 1544, a power manager 1545, a database manager 1546, a package manager 1547, a connectivity manager 1548, a notification manager 1549, a location manager 1550, a graphic manager 1551, a security manager 1552, or the like.

The run time library 1535 may include, for example, a library module that a compiler uses in order to add new functions through a programming language while the applications 1570 are in progress. The run time library 1535 may perform functions of input/output management, memory management, or arithmetic calculation.

The application manager 1541 manages, for example, a life cycle of at least one application among the applications 1570. The window manager 1542 manages a Graphical User Interface (GUI) resource used in the screen. The multimedia manager 1543 identifies formats for reproducing various media files, and performs encoding or decoding of media files by using a codec corresponding to each format. The resource manager 1544 manages resources such as source code, memory or storage spaces of at least one application among the applications 1570.

The power manager 1545 manages a battery or electrical power by operating with a Basic Input/Output System (BIOS), and provides power information necessary for the operation. The database manager 1546 generates, retrieves or changes data that is to be used in at least one of the applications 1570. The package manager 1547 manages the installation or the updating of applications distributed in the form of a package file.

The connectivity manager 1548 manages a wireless connection of, for example, Wi-Fi or Bluetooth. The notification manager 1549 may display or notify events such as received messages, appointments, and proximity notifications to a user without disturbance. The location manager 1550 manages location information of the electronic device. The graphic manager 1551 manages graphic effects to be provided to a user and user interfaces related to the graphic effects. The security manager 1552 provides a general security function required for system security or user authentication. According to an embodiment of the present invention, when the electronic device 101 adopts a phone call function, the middleware 1530 further includes a telephony manager for managing functions of a voice call or a video call of the electronic device.

The middleware 1530 includes a middleware module that is comprised of a combination of various functions of the above-described elements. The middleware 1530 provides modules that are specialized according to the type of operating system in order to provide differentiated functions. In addition, some typical elements may be dynamically removed from the middleware 1530, or new elements may be added to the middleware 1530.

The API 1560 (e.g., API 145) is a group of API programming functions, and may be provided with a different configuration according to an operating system. For example, one set of APIs may be provided to each platform for Android or iOS, and at least two sets of APIs may be provided to each platform for Tizen™.

The applications 1570 (e.g., applications 147) may include, for example, a home application 1571, a dialer application 1572, a Short Message Service (SMS)/MultiMedia Message Service (MMS) application 1573, an Instant Messaging (IM) application 1574, a browser application 1575, a camera application 1576, an alarm application 1577, a contact application 1578, a voice dial application 1579, an e-mail application 1580, a calendar application 1581, a media player application 1582, an album application 1583, a clock application 1584, a healthcare application (e.g., an application for measuring the amount of exercise or blood sugar) (not shown), an environmental information application (e.g., an application for providing information of atmospheric pressure, humidity, or temperature) (not shown), or the like.

According to an embodiment of the present invention, the applications 1570 may include an application that supports the exchange of information between the electronic device 101 and the first external device 102 and the second external device 104. The information-exchange-related application may include, for example, a notification relay application for relaying specific information to the external electronic device, or a device management application for managing the external electronic device.

For example, the notification relay application may include a function of transferring notification information created in other applications (e.g., the SMS/MMS application 1573, the e-mail application 1580, the health care application, the environmental information application, or the like) of the electronic device to the first external device 102 and the second external device 104. In addition, the notification relay application may receive, for example, notification information from an external electronic device and provide the same to the user. The device management application may manage (e.g., install, delete, or update), for example, at least some functions (e.g., making external electronic device (or some elements) active or inactive, or adjusting the brightness (or resolution) of a display) of the external electronic device that communicates with the electronic device, applications executed in the external electronic device, or services (e.g., a phone call service, or a messaging service) provided in the external electronic device.

According to an embodiment of the present invention, the applications 1570 may include applications (e.g., healthcare application), which are designated according to the properties (e.g., the type of electronic device, for example, mobile medical device) of the first electronic device 102 and the second electronic device 104. According to an embodiment of the present invention, the application 1570 may include applications received from the first electronic device 102 and the second electronic device 104. According to an embodiment of the present invention, the applications 1570 may include preloaded applications or third party applications downloaded from a server. Names of the elements of the program module 1500 as shown in FIG. 15 may vary with the type of operating system.

According to an embodiment of the present invention, at least a part of the programming module 1500 may be implemented in software, firmware, hardware, or a combination of two or more thereof. At least a portion of the programming module 1500 may, for example, be implemented (e.g., executed) by a processor (e.g., the AP 210). At least a part of the programming module may include, for example, a module, a program, a routine, a set of instructions and/or a process for performing one or more functions.

The term “module” used in an embodiment of the present invention may refer to, for example, a “unit” including one of hardware, software, and firmware, or a combination of two or more of the hardware, software, and firmware. The term “module” may be interchangeable with a term, such as “a unit,” “a logic,” “a logical block,” “a component,” or a “circuit.” The term “module” may refer to a minimum unit of an integrated component or a part thereof. The term “module” may refer to a minimum unit for performing one or more functions or a part thereof. A “module” may be mechanically or electronically implemented. For example, a “module” according to an embodiment of the present invention may include at least one of an Application-Specific Integrated Circuit (ASIC), a Field-Programmable Gate Array (FPGA), and a programmable-logic device for performing operations which are known or will be developed hereafter.

According to an embodiment of the present invention, at least part of a device (for example, modules or functions thereof) or a method (for example, operations) according to an embodiment of the present invention may be embodied by, for example, an instruction stored in a non-transitory computer readable storage medium provided in a form of a programming module. The instruction, when executed by at least one processor (e.g., the processor 120, 220, or 1410), causes the at least one processor to perform a function corresponding to the instruction. The non-transitory computer-readable storage medium may, for example, be a memory that may be included in each of the memories 130, 230, and 1430. At least a part of the programming module may, for example, be implemented (e.g., executed) by a processor. At least a part of the programming module may include, for example, a module, a program, a routine, a set of instructions and/or a process for performing one or more functions.

The non-transitory computer readable recoding medium may include magnetic media, such as a hard disk, a floppy disk and a magnetic tape, optical media, such as a Compact Disc Read Only Memory (CD-ROM) and a Digital Versatile Disc (DVD), magneto-optical media, such as a floptical disk, and a hardware device configured to store and execute a program instruction (for example, a programming module), such as a Read Only Memory (ROM), a Random Access Memory (RAM), a flash memory, and the like. In addition, the program instructions may include high level language codes, which can be executed in a computer by using an interpreter, as well as machine codes generated by a compiler. The aforementioned hardware device may be configured to operate as one or more software modules in order to perform the operation of an embodiment of the present invention, and vice versa.

According to an embodiment of the present invention, disclosed is a non-transitory computer-readable recording medium storing a program executed by a processor in a computer to perform the operations of loading a template of a web application, receiving an input of content corresponding to the loaded template, and combining the input content with the loaded template to create the web application.

According to an embodiment of the present invention, disclosed is a non-transitory computer-readable recording medium storing a program executed by a processor in a computer to perform the operations of receiving a selection of at least one web application created on the basis of a template, loading a template of the selected web application, downloading content of the selected web application from a shared storage space that stores the web application, and combining the downloaded content with the loaded template to complete the selected web application.

An electronic device according to an embodiment of the present invention, may receive programs including instructions for performing a method of processing web applications from program providing devices that are connected by wired or wireless communication, and may store the same. Alternatively, various electronic devices or servers may be the program providing devices. The program providing devices may include a memory for the programs, a communication module for wired or wireless communication with the electronic device, and a processor for transmitting the corresponding program to the electronic device automatically or by a request of the electronic device.

A module or a programming module according to the present invention may include at least one of the described elements, a few of the elements may be omitted, or additional elements may be included. Operations executed by a module, a programming module, or other elements according to an embodiment of the present invention may be executed sequentially, in parallel, repeatedly, or in a heuristic manner. Further, some operations may be executed according to another order or may be omitted, or other operations may be added.

Embodiments of the present invention disclosed in the present specification and the accompanying drawings are examples for easily describing the technical contents of the present invention and helping understanding of the present invention, but the present invention is not limited thereto. Therefore, in addition to the embodiments described herein, the scope of the present invention should be construed to include all modifications or modified forms drawn based on the technical idea of the present invention, as defined by the appended claims and their equivalents.

What is claimed is:

1. A method of processing a web application in an electronic device, the method comprising:
loading a template of the web application;
receiving an input of content corresponding to the loaded template; and
combining the input of content with the loaded template to create the web application.

2. The method of claim 1, wherein loading the template comprises:
receiving a selection of the template of at least one web application;
determining whether or not the selected template has been cached;
loading the selected template when the selected template has been cached;
downloading the selected template from a shared storage space that stores the template of the web application when the selected template has not been cached;
caching the downloaded template; and
loading the downloaded template.

3. The method of claim 1, further comprising storing the created web application in the shared storage space.

4. The method of claim 1, wherein the template includes content type information indicating at least one of a type of content and a number of contents, which are defined in the template, and wherein
loading the template comprises:
identifying the content type information included in the template; and
providing a user interface for receiving an input of content on a basis of the content type information.

5. The method of claim 4, wherein the template is created in at least one of a defined type that is defined in the web application or an undefined type, the type of content comprises the type of content according to at least one of the defined type or the undefined type, wherein the defined type comprises the type of content that is defined in the web application, and wherein the undefined type comprises the type of content that is used in the template and is different than the defined type.

6. The method of claim 1, wherein the template comprises execution commands for defining at least one of content output types of a static type, a dynamic type, or a user interactive type.

7. A method of processing a web application in an electronic device, the method comprising:
receiving a selection of at least one web application created on a basis of a template;
loading a template of the selected web application;
downloading content of the selected web application from a shared storage space that stores the web application; and
combining the downloaded content with the loaded template to complete the selected web application.

8. The method of claim 7, wherein loading the template comprises:
determining whether or not the template of the selected web application has been cached;
loading the selected template when the selected template has been cached;
downloading the template of the selected web application from the shared storage space that stores the template of the web application when the selected template has not been cached;
caching the downloaded template; and
loading the downloaded template.

9. A method of processing a web application in a server, the method comprising:
receiving the web application created on a basis of a template;
storing the received web application in a shared storage space;
receiving a request for content of the web application from an electronic device; and
transmitting the content of the web application requested by the electronic device from the shared storage space to the electronic device that requested the content.

10. An electronic device, comprising:
a memory configured to store a template of a web application; and
a processor configured to load the template of the web application, receive an input of content corresponding to the template, and combine the input content with the loaded template to create the web application.

11. The electronic device of claim 10, wherein the processor is further configured to receive a selection of the template of at least one web application, load the selected template that has been cached when the selected template has been cached in the memory, download the selected template from a shared storage space that storing the template of the web application when the selected template has not been cached in the memory, cache the downloaded template, and load the downloaded template.

12. The electronic device of claim 10, wherein the processor is further configured to store the created web application in the shared storage space.

13. The electronic device of claim 10, wherein the template includes content type information indicating at least one of a type of content and a number contents, which are defined in the template, and wherein
the processor is further configured to identify the content type information included in the template, and provide a user interface for receiving an input of content on a basis of the content type information.

14. The electronic device of claim 13, wherein the template is created in at least one of a defined type that is defined in the web application or an undefined type, the type of content comprises the type of content according to at least one of the defined type or the undefined type, the defined type comprises the type of content that is defined in the web application, and the undefined type comprises the type of content that is used in the template and is different than the defined type.

15. The electronic device of claim 10, wherein the template comprises execution commands for defining at least one of content output types of a static type, a dynamic type, or a user interactive type.

16. An electronic device, comprising:
a memory configured to store a template of a web application; and
a processor configured to receive a selection of at least one web application created on a basis of a template, load a template of the selected web application, download content of the selected web application from a shared storage space that stores the web application, and combine the downloaded content with the loaded template to complete the selected web application.

17. The electronic device of claim 16, wherein the processor, when the selected template has been cached, is further configured to load the selected template when the selected template has not been cached, download the template of the selected web application from the shared storage space that stores the template of the web application, cache the downloaded template, and load the downloaded template.

18. A server, comprising:
a communication interface configured to establish communication between the server and at least one electronic device; and
a processor configured to receive a web application created on a basis of a template, store the received web application in a shared storage space, receive a request for content of the web application from the at least one electronic device, and transmit the content of the web application requested by the at least one electronic device from the shared storage space to the at least one electronic device that requested the content.

19. A non-transitory computer-readable recording medium storing a program executed by a processor in a computer to perform a method of:
loading a template of the web application;
receiving an input of content corresponding to the loaded template; and
combining the input content with the loaded template to create the web application.

20. A non-transitory computer-readable recording medium storing a program executed by a processor in a computer to perform a method of:
receiving a selection of at least one web application created on a basis of a template;
loading a template of the selected web application;
downloading content of the selected web application from a shared storage space that stores the web application; and
combining the downloaded content with the loaded template to complete the selected web application.
